(19) United States
(12) Patent Application Publication
(10) Pub. No.: US 2006/0195986 A1
(43) Pub. Date: Sep. 7, 2006

(54) Footboard for a hospital bed

(76) Inventors: Reza Hakamiun, Charleston, SC (US); Kenith W. Chambers, Batesville, IN (US); Thomas Uzzle, Mt. Pleasant, SC (US)

Correspondence Address: Intellectual Property Group;Bose McKinney & Evans LLP, 2700 First Indiana Plaza, 135 North Pennsylvania Street, Indianapolis, IN, 46204, US

(21) Appl. No.: 11/368,982

(22) Filed: Mar. 6, 2006

Related U.S. Application Data
(60) Provisional application No. 60/659,368, filed on Mar. 7, 2005.

(51) Int. Cl. A61G 7/00

(52) U.S. Cl. 5/600; 5/713; 5/53.1

(57) ABSTRACT

A hospital bed including footboard and a removable air supply. The hospital bed is configured to support a bariatric, large or obese patient.

### CROSS-REFERENCE TO RELATED APPLICATION

This application claims benefit of U.S. Provisional Patent Application Ser. No. 60/659,368, filed Mar. 7, 2005, entitled “Footboard For a Hospital Bed” to Hakamiun et al., the disclosure of which is expressly incorporated by reference herein.

This application relates to U.S. Provisional Patent Application Ser. No. 60/598,817, titled Mattress Assembly, to Chambers et al. This application relates to U.S. Utility patent application Ser. No. ______ entitled “Siderails for a Hospital Bed” (Attorney Docket No. 8266-1206), filed concurrently herewith, U.S. Utility application Ser. No. ______ entitled “Hospital Bed” (Attorney Docket No. 8266-1339), and U.S. Utility application Ser. No. ______ entitled “Support Surface System” (Attorney Docket No. 8266-1337), filed concurrently herewith, the disclosures of which are expressly incorporated by reference herein.

Additionally, this application relates to U.S. patent application Ser. No. 10/890,357, filed on Jul. 13, 2004, which is a continuation application of U.S. application Ser. No. 10/254,343, filed Sep. 25, 2002, now U.S. Pat. No. 6,760,939, which is a divisional application of U.S. application Ser. No. 09/946,886, filed on Sep. 5, 2001, now U.S. Pat. No. 6,467,113, which is a continuation application of U.S. application Ser. No. 09/465,872, filed on Dec. 16, 1999, now U.S. Pat. No. 6,295,675, which is a divisional application of U.S. application Ser. No. 08/917,145 filed on Aug. 25, 1997, now U.S. Pat. No. 6,021,533, all of which are expressly incorporated by reference herein.

### BACKGROUND AND SUMMARY OF THE INVENTION

The present invention relates to a hospital bed and more particularly to a hospital bed for a bariatric patient. Bariatric beds are designed for use by obese patients. Bariatric beds typically include a larger than average heavy duty frame to support the patient size and weight. The bed of the present disclosure is configured to support patients up to 1000 pounds, preferably patients between 250 pounds and 1000 pounds, although it is within the scope of the present invention to accommodate patients of 400 pounds or more including weights of greater than 1000 pounds.

According to one embodiment of the present invention, a patient support includes a frame, a deck, a mattress supported by the deck, and an air supply. The mattress includes an upper surface and a lower surface. Additionally, a footboard is provided. The footboard is removable from the patient support. The footboard includes a caregiver interface and an air supply retaining assembly. The air supply retaining assembly is configured to removably couple the air supply to the footboard.

Additional features and advantages of the invention will become apparent to those skilled in the art upon consideration of the following detailed description of illustrated embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of an illustrative embodiment patient support including a footboard, an air supply, and an air supply retaining assembly according to the present disclosure;

FIG. 2 is a top view of the patient support of FIG. 1 including the illustrative footboard;

FIG. 3 is a partial top view of the patient support similar to FIG. 2 with the footboard removed;

FIG. 4 is a perspective view of the footboard showing a caregiver side of the footboard;

FIG. 5 is a perspective view of the footboard showing a patient side of the footboard;

FIG. 6A is a perspective view of the footboard showing the bottom of the footboard including a pair of connector assemblies;

FIG. 6B is an enlarged perspective view of one of the pair of connector assemblies of FIG. 6A;

FIG. 7 is an exploded perspective view of the footboard and air supply with the air supply pulled away showing the air supply retaining assembly;

FIG. 8 is another exploded perspective view of the illustrative footboard;

FIG. 9A is a perspective view of the illustrative retaining assembly in a disconnected arrangement;

FIG. 9B is a perspective view of the illustrative retaining assembly in a connected arrangement;

FIG. 10 is a perspective view of an alterative embodiment retaining assembly shown in the disconnected arrangement; and

FIG. 11 is a perspective view of the retaining assembly of FIG. 10 shown in the connected arrangement.

### DETAILED DESCRIPTION OF THE DRAWINGS

The embodiments described below and shown in the figures are merely exemplary and are not intended to limit the invention to the precise forms disclosed. Instead, the embodiments were selected for description to enable one of ordinary skill in the art to practice the invention.

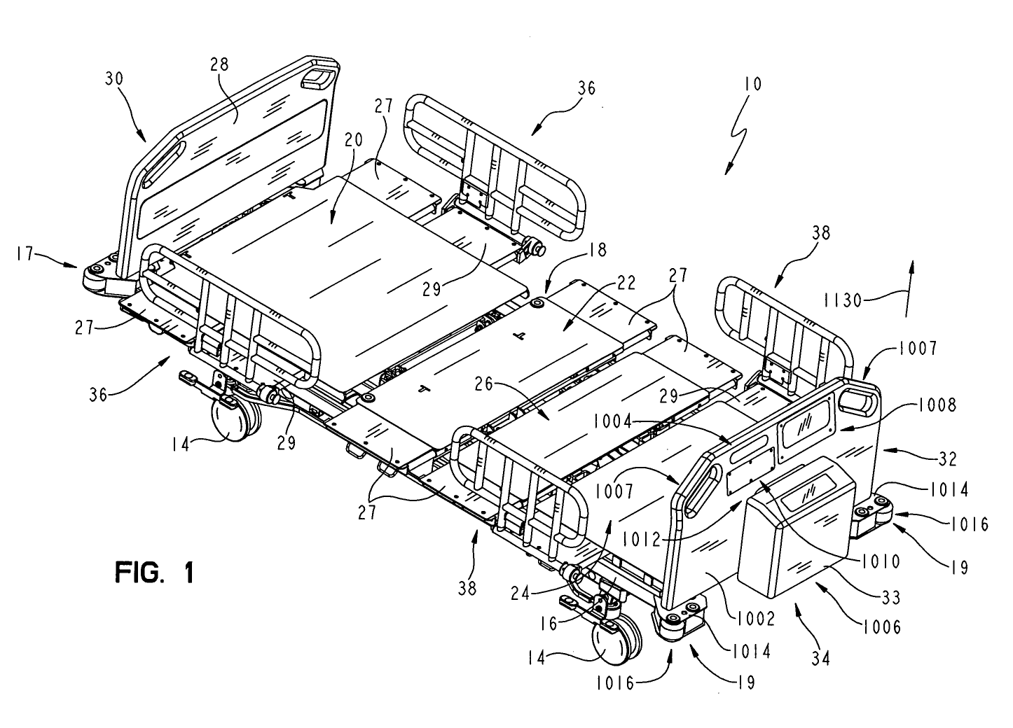

Referring initially to FIG. 1, a patient support 10 is illustrated as including a base frame 12 supported by a plurality of casters 14. An intermediate frame 16 is supported by the base frame 12 and is coupled to an articulating support deck 18. Frame 16 includes a pair of head end flanges 17 and a pair of foot end flanges 19. The support deck 18 is of conventional design and illustratively includes a plurality of sections configured to articulate relative to one another, including a head section 20 pivotally coupled to a seat section 22, and a foot section 24 pivotally coupled to the seat section 22. In the illustrative embodiment, a thigh section 26 is pivotally coupled intermediate the seat section 22 and the foot section 24. Further illustratively, the seat section 22 may be rigidly mounted to the intermediate frame 16 to prevent movement therebetween.

The support deck 18 includes sliding panels 27 and siderail sliding panels 29 which may be moved laterally to expand and retract the width of the deck 18. Examples of expanding support decks are provided in U.S. patent application Ser. No. ______ entitled “BARIATRIC BED”, filed Jul. 28, 2004 (Attorney Docket No. 8266-0741) and U.S. Pat. Nos. 6,212,714 and 6,357,065, the disclosures of which are expressly incorporated by reference herein.

A headboard 28 is mounted to the intermediate frame 16 adjacent a head end 30 of patient support 10, and a footboard 32 is mounted to foot end flanges 19 of intermediate frame 16 adjacent a foot end 34 of patient support 10. Additionally, an air unit 33 is attached to footboard 32. The patient support 10 further includes a pair of head end siderail assemblies 36 and a pair of foot end siderail assemblies 38 coupled to the support deck 18 through the associated siderail sliding panels 29 on opposite sides of the patient support 10. Details of the siderails are disclosed in U.S. patent application Ser. No. ______ entitled “Siderails for a Hospital Bed”. (Attorney Docket No. 8266-1206), filed concurrently herewith, the disclosure of which is expressly incorporated by reference herein.

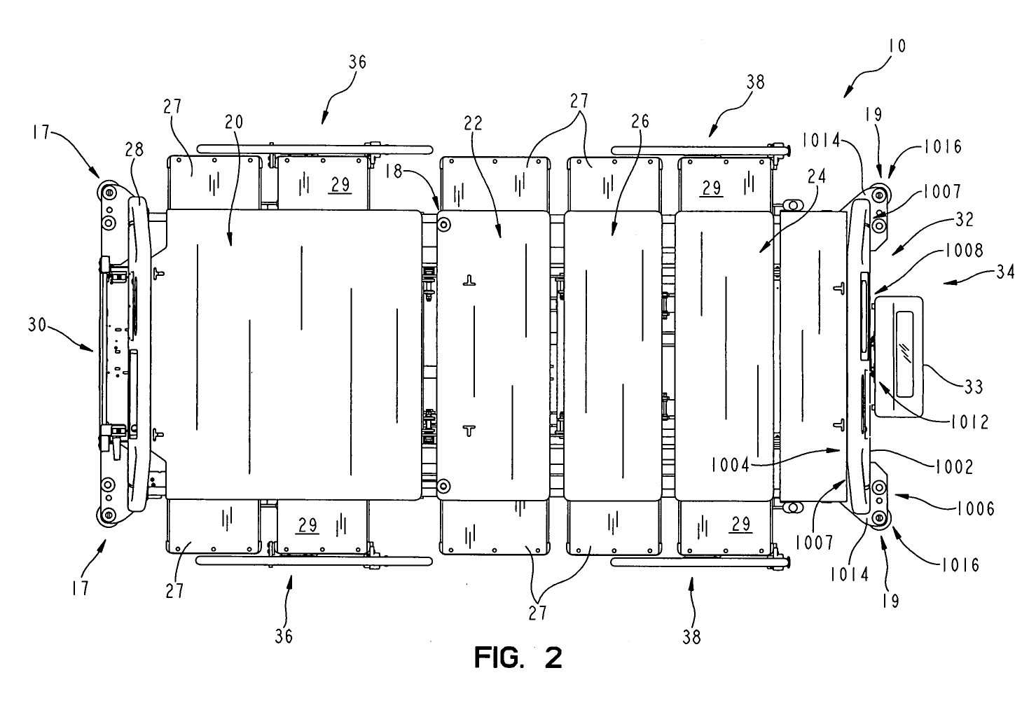

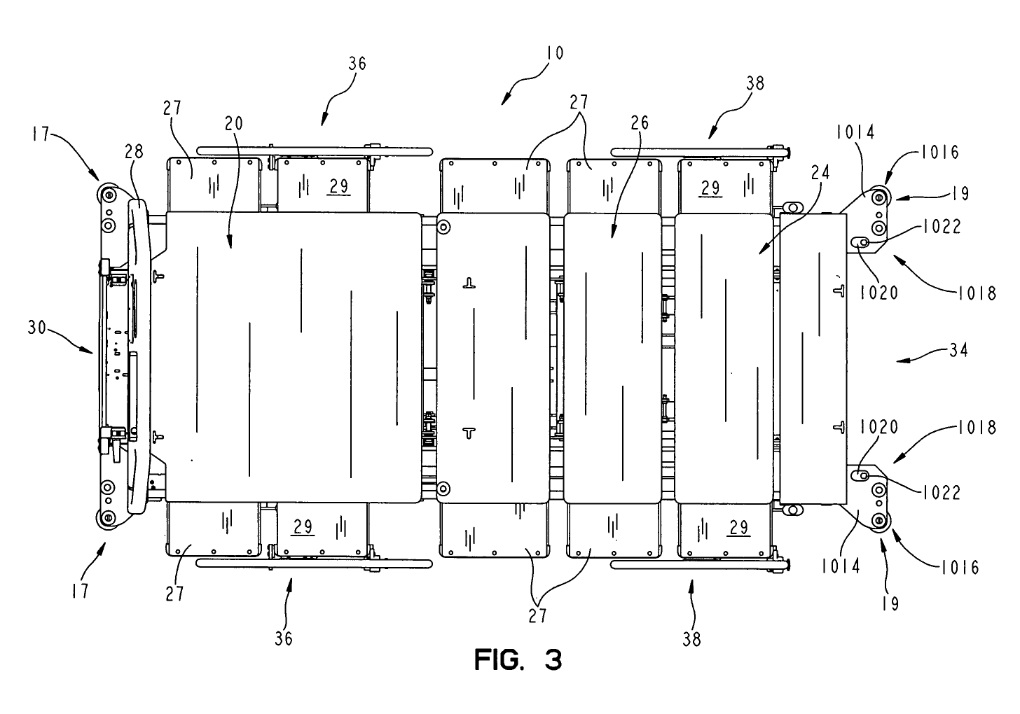

As shown in FIG. 1, footboard 32 includes a body 1002 including a patient support side or first side 1004 and a caregiver side or second side 1006, a pair of grips 1007, a caregiver interface 1008, a bed scale interface 1010, and an air supply retaining assembly 1012. Grips 1007 help enable patient ingress and egress from patient support 10 and aid in removal of footboard 32. Footboard 32 is configured to include an attached position (FIG. 2) and a removed position (FIG. 3).

As shown in FIG. 3, each foot end flange 19 includes a body 1014, a bumper 1016, and a footboard receiver 1018. Footboard receiver 1018 includes a receiver channel 1020 and a footboard receptacle 1022.

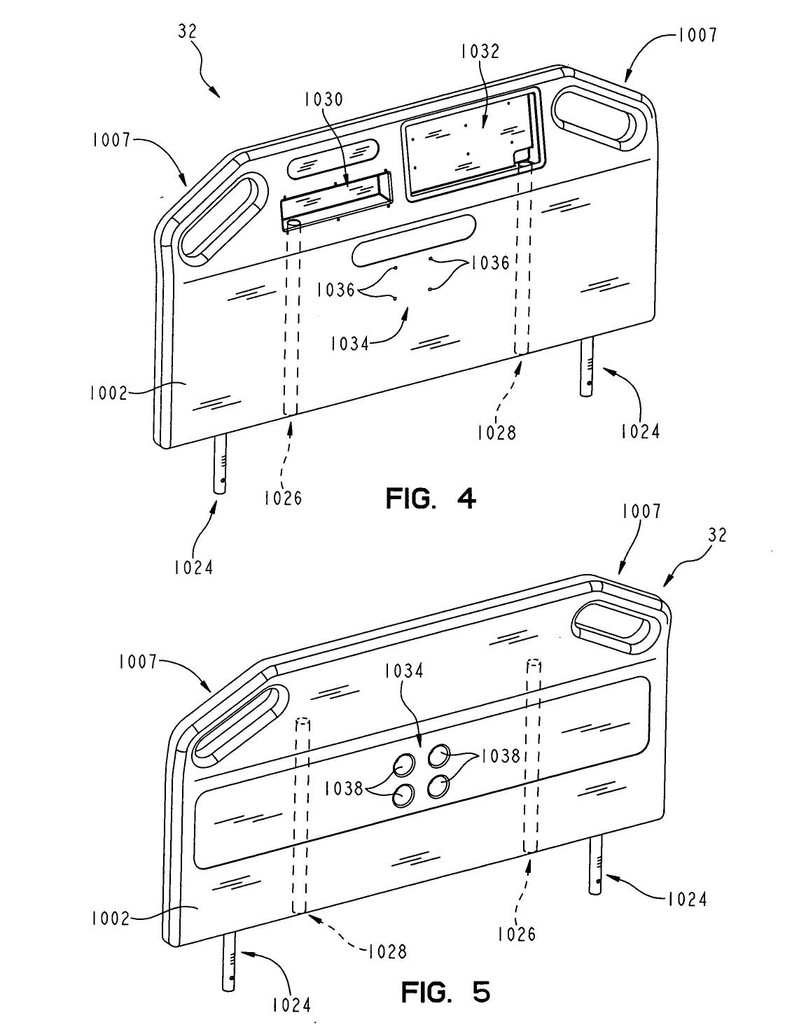

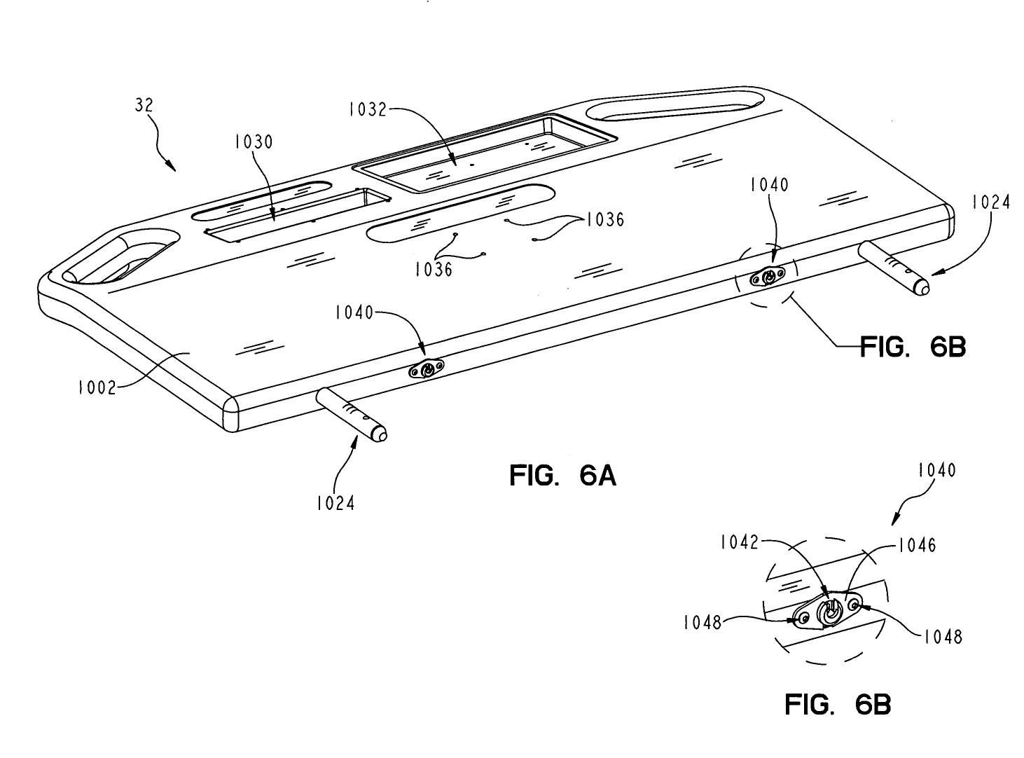

As shown in FIGS. 4-5, footboard 32 further includes a pair of footboard attachment members 1024, a first conduit 1026, and a second conduit 1028. First and second conduits 1026, 1028 are both steel tubes and are located inside body 1002. Each of the conduits 1026, 1028 provides a channel for electrical cabling to be described herein. Conduits 1026, 1028 are placed in footboard 32 after a blow molding operation of body 1002 and before a foaming operation. Additionally, conduits 1026, 1028 provide additional strength to body 1002 of footboard 32. Added strength is also provided by footboard attachment members 1024 and thickness reducers or kiss-offs 1038. These three features and the foam provide substantial strength to footboard 32.

Body 1002 includes a bed scale receiver 1030, an interface receiver 1032, and retaining assembly receivers 1034. Retaining assembly receivers 1034 each includes a rivet receiver 1036 and a thickness reducer 1038. In the preferred embodiment, body 1002 is a single blow molded plastic piece filled with Urethane foam.

Footboard 32 is produced by blow molding, which provides a sealed double wall structure. This structure is then bored to provide holes (not shown) for insertion of the attachment members 1024 and conduits 1026, 1028. These holes enter into receivers 1030, 1032 and exit the bottom of body 1002. This secondary operation includes boring retaining receivers 1034. Conduits 1026, 1028 and attachment members 1024 are then inserted through the holes and held in place by a removable fixture (not shown) during an expanding foam process. A plurality of threaded female inserts 1029 are then secured at the bottom of footboard 32 with a plurality of screws 1031. Inserts 1029 are used to secure a bracket 1046 enabling use of a strain relief fitting 1042 for the cables.

Thickness reducers 1038 reduce the thickness of footboard 32 and provided rigidity to footboard 32. Thickness reducers 1038 allow shorter rivets or bolts to be used for attaching retaining assembly 1012 to rivet receivers 1036. Body 1002 further includes a molded texture (not shown) over substantially the entire surface to provide a textured surface for positive gripping by a user (not shown). In construction, the same mold used to create body 1002 can be used to mold headboard 28 by removing inserts (not shown) necessary to create bed scale receiver 1030 and interface receiver 1032 and optionally not inserting conduits 1026, 1028.

In an alterative embodiment, body 1002 is made by attaching a molded front section (not shown) to a molded back section (not shown). This would allow thickness reducers 1038 to be eliminated by attaching retaining assembly 1012 to rivet receivers 1036 prior to mating the front section and back section.

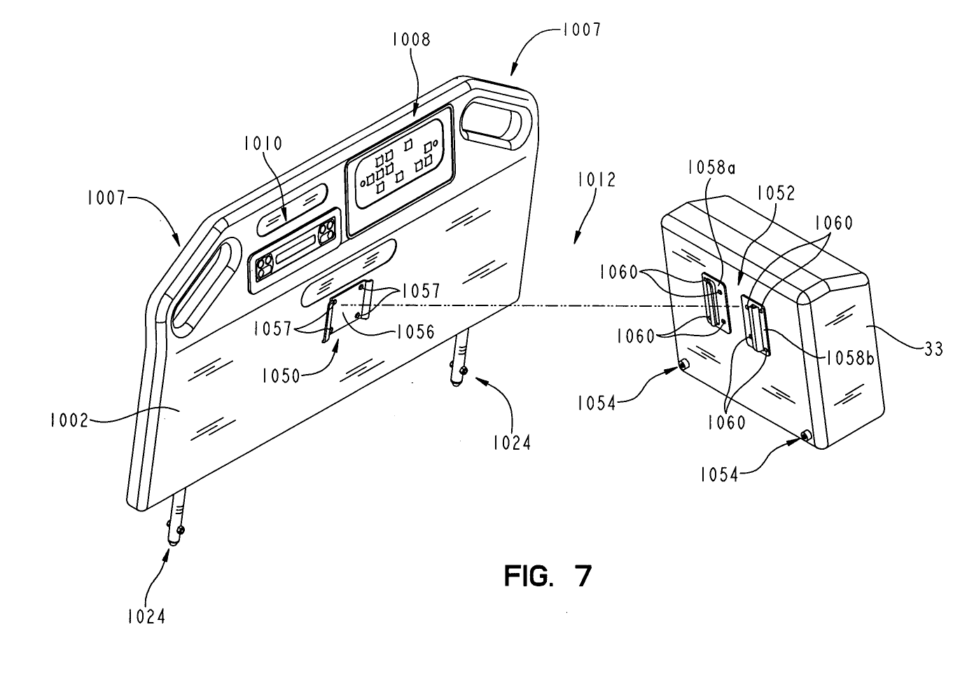

As shown in FIG. 6A, footboard 32 further includes a pair of connector assemblies 1040, shown in greater detail in FIG. 6B. Connector assembly 1040 includes strain relief fitting 1042, bracket 1046 configured to hold strain relief fitting 1042 in place, and a pair of couplers 1048 configured to couple bracket 1046 to footboard 32. Couplers 1048 include screws 1031 and inserts 1029.

Conduits 1026, 1028 provide a hidden and safe routing for cables to the electrical components of patient support 10. Cables have a quick connect connector (not shown) to facilitate removal of footboard 32 from bed frame 12. Each conduit 1026, 1028 is outfitted with bracket 1046 and fitting 1042 to keep the cables from being pulled out of footboard 32 causing damage to the electrical components.

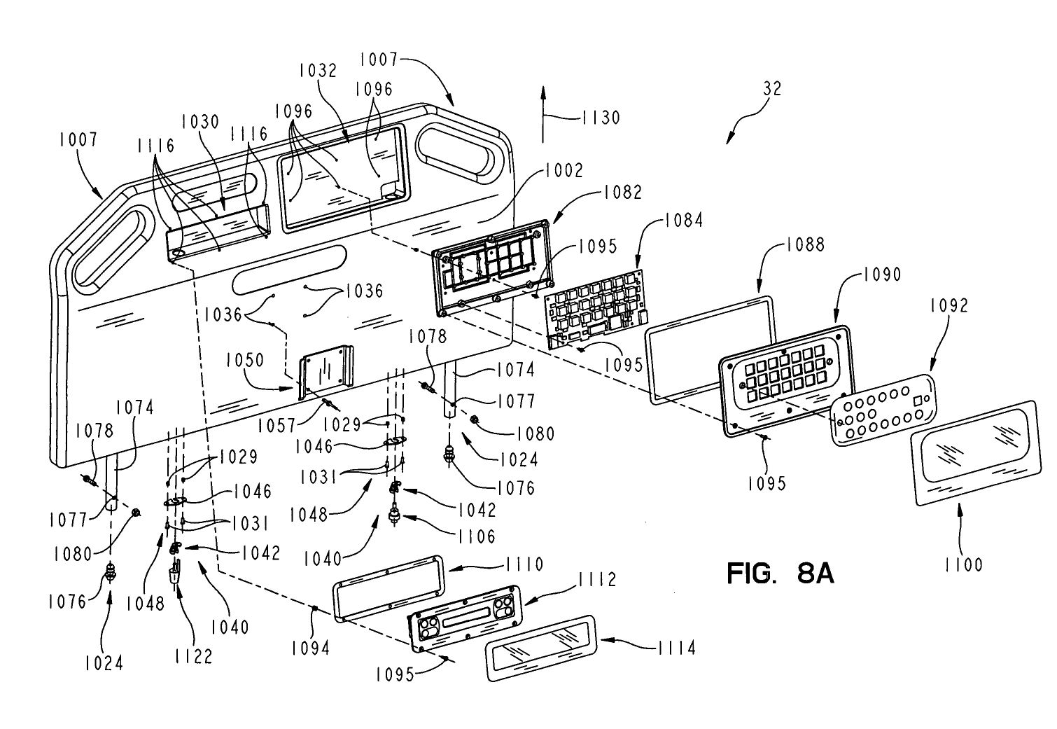

As shown in FIG. 7, air supply retaining assembly 1012 includes a footboard bracket assembly 1050, an air supply bracket assembly 1052, and a pair of support bumpers 1054. Footboard bracket assembly 1050 includes a hanger bracket 1056 and a plurality of pop-rivets 1057 configured to cooperate with rivet receiver 1036 to couple hanger bracket 1056 to body 1002. Air supply bracket assembly 1052 includes a pair of air supply brackets 1058a, 1058b and a plurality of mounting members 1060 configured to mount air supply brackets 1058 to air supply unit 33. Support bumpers 1054 are provided to reduce or prevent marring of footboard 32 and vibration noise caused by removal, attachment, and operation of air supply unit 33.

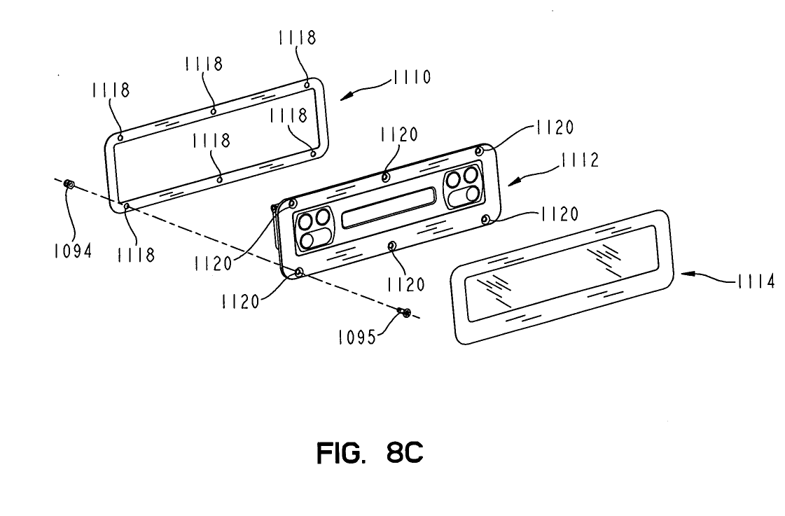

As shown in FIGS. 9A-9B, air supply brackets 1058a, 1058b each include a body 1062 and a hanger bracket receiving tab 1064 created by a stamping process. Hanger bracket 1056 includes a body 1066, a pair of supply bracket members 1068, and a pair of stop tabs 1070. To attach air supply unit 33 the user places air supply unit 33 near footboard 32 so hanger bracket receiving tabs 1064 interact with bracket members 1068. The user then allows receiving tabs 1064 to move until a portion 1072 of each receiving tab 1064 contacts stop tabs 1070. To remove air supply unit 33 the user lifts unit 33 until each receiving tab 1064 is clear of each bracket member 1068.

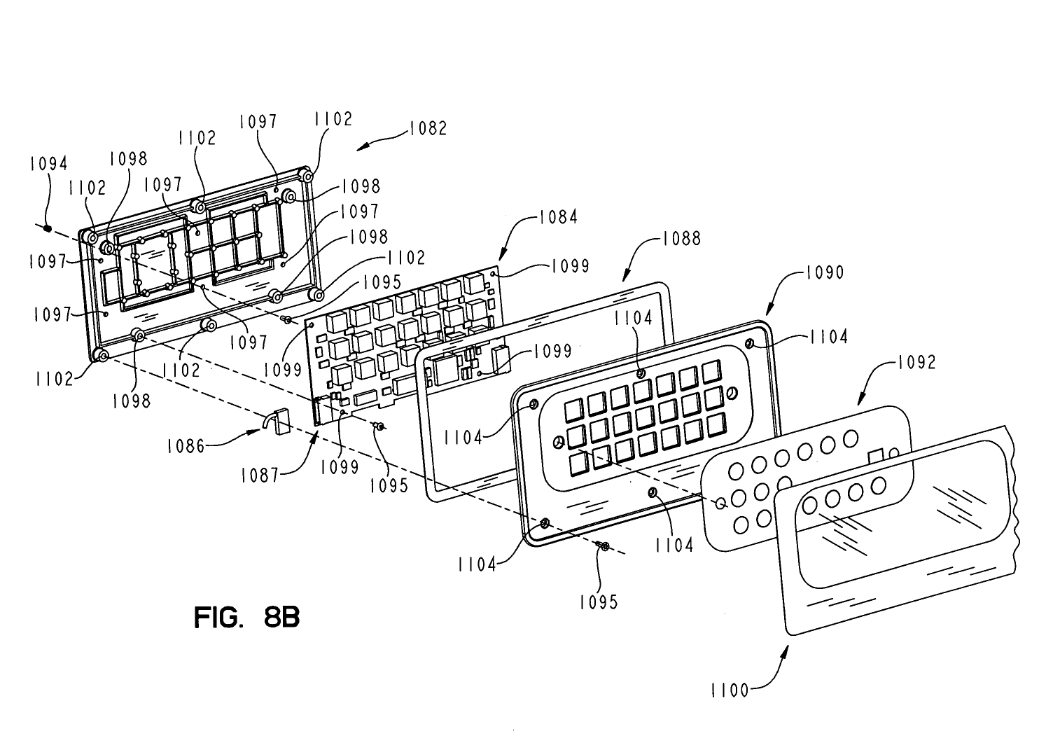

As shown in FIG. 8, footboard attachment members 1024 include a main body 1074, an end cap 1076, a screw receiver 1077, a screw 1078, and a nut 1080 configured to receive screw 1078. Main body 1074 is configured to be received by footboard receiver 1018. Once main body 1074 is received by footboard receiver 1018, screw 1078 is placed through screw receiver 1077 and into nut 1080 to secure main body 1074 in footboard receiver 1018.

Caregiver interface 1008 includes a support plate 1082, a caregiver control board 1084, a caregiver control cable 1086 configured to couple to control board 1084 through a connector 1087, a gasket 1088, a cover 1090, a label kit 1092, and a label 1100. A plurality of threaded inserts 1094 are provided to be received by openings 1096 in interface receiver 1032. The plurality of threaded inserts 1094 are configured to receive a plurality of screws 1095 to engage with a plurality of openings 1097 in support plate 1082. Screws 1095, openings 1097, and inserts 1094 cooperate to couple support plate 1082 to interface receiver 1032. Support plate 1082 further includes a plurality of support posts 1098 configured to receive screws 1095 to couple support plate 1080 through a plurality of openings 1099. Support plate 1082 further includes a plurality of cover posts 1102. Cover posts are configured to receive screws 1095 through openings 1104 in cover 1090. Cover posts 1090, screws 1095, and openings 1104 cooperate to couple cover 1090 to support plate 1082. A caregiver cable 1106 is provided to couple caregiver interface 1008 to a processor (not shown) of patient support 10. Details of the Caregiver interface or controller is disclosed in U.S. patent application Ser. No. ______ entitled “HOSPITAL BED” (8266-1339), the disclosure of which is expressly incorporated by reference herein.

Bed scale interface 1010 includes a gasket 1110, a bed scale system 1112, and a label 1114. Bed scale receiver 1030 includes a plurality of openings 1116 configured to receive threaded inserts 1094. Screws 1095 are configured to couple bed scale system 1112 and gasket 1110 to bed scale receiver 1030 through gasket openings 1118 and system openings 1120. A bed scale coupler 1122 is provided to couple bed scale interface 1010 to a bed scale (not shown) of patient support 10. Details of the bed scale and bed scale interface are disclosed in U.S. patent application Ser. No. ______ entitled “HOSPITAL BED” (8266-0880), the disclosure of which is expressly incorporated by reference herein.

In operation of removal of footboard 32, the caregiver or service technician removes a cable tie (not shown) securing coupler 1122 and a grounding screw (not shown) securing a ground wire (not shown) from coupler 1122 to frame 12. Next, the caregiver or service technician unplugs bed scale coupler 1122 and caregiver cable 1106 from connector assemblies 1040. The caregiver or service technician removes screw 1078 from screw receiver 1077 after removing nut 1080. The caregiver or service technician grasps grips 1007 and lifts footboard 32 in an upward direction 1130. This removes footboard 32 from patient support 10 to aid in transportation and storage of patient support 10.

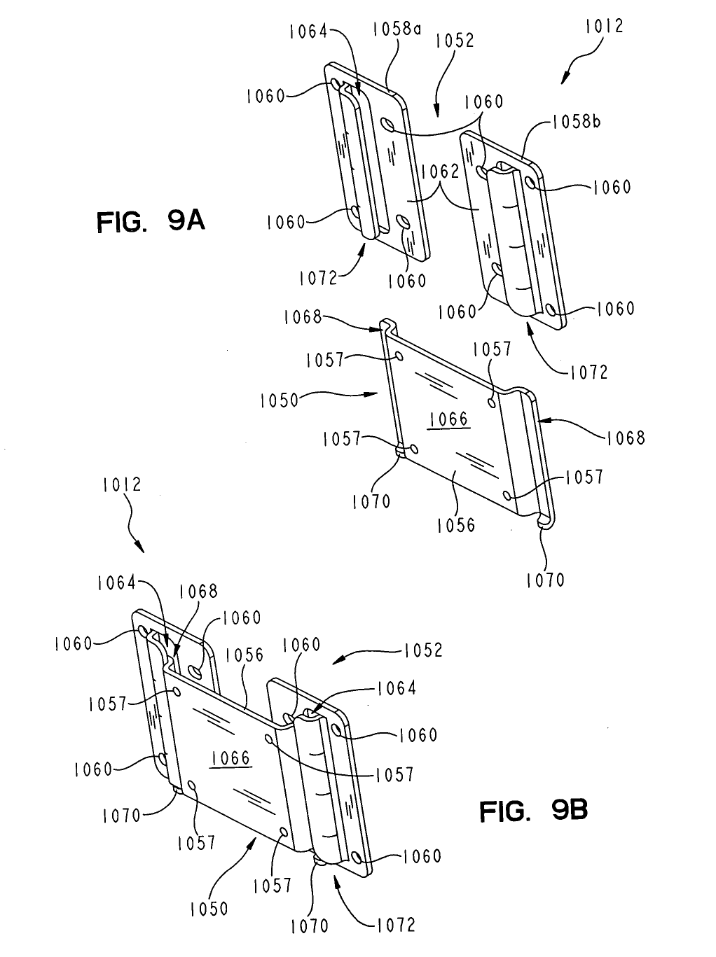

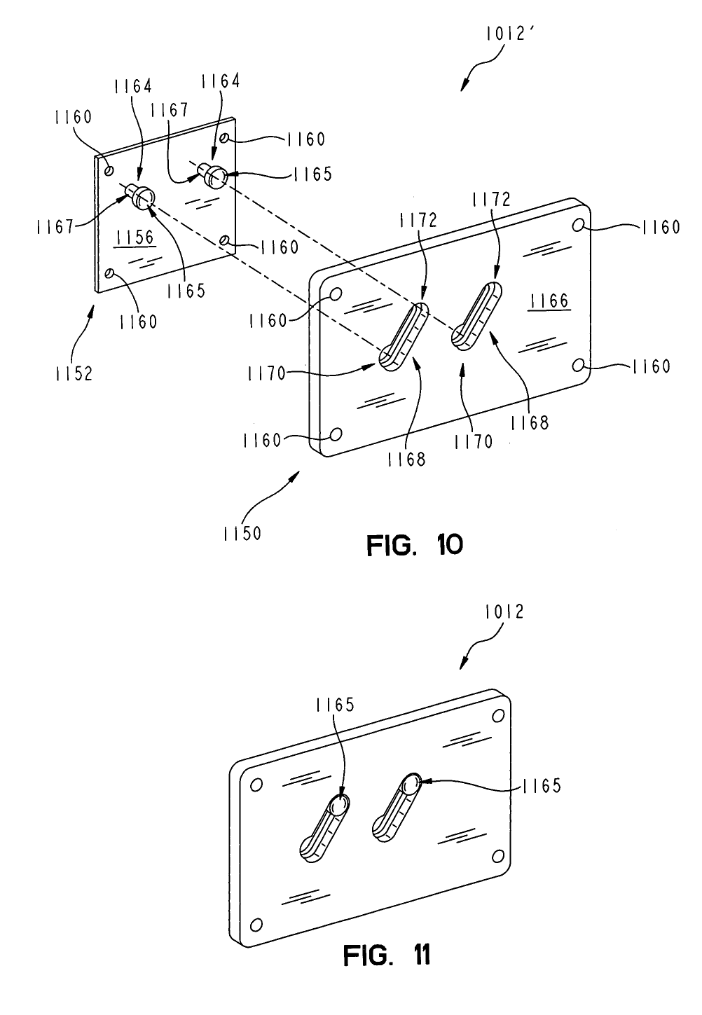

Another illustrative embodiment air supply retaining assembly 1012′ is shown in FIGS. 10-11. Air supply retaining assembly 1012′ includes a footboard bracket assembly 1150 and an air supply bracket assembly 1152. Footboard bracket assembly 1150 includes a hanger body 1166 and a plurality of pop-rivets (not shown) configured to cooperate with rivet receiver 1036 to couple hanger bracket 1166 to body 1002. Air supply bracket assembly 1152 includes a supply brackets body 1156 and a plurality of mounting members 1160 configured to mount supply body 1156 to air supply unit 33.

As shown in FIGS. 10-11, supply bracket body 1156 includes a pair of hanger posts 1164 having a top 1165 and a base 1167. Top 1165 has a larger diameter then base 1167. Hanger body 1166 includes a pair of supply bracket channels 1168. Supply channels 1168 define a first end 1170 of a first diameter 1171 and a second end 1172 with a second diameter 1173. First diameter 1171 is sized to receive top 1165. Second diameter 1173 is sized to retain base 1167 in channel 1168. In operation to attach air supply unit 33, the user places air supply unit 33 near footboard 32 so hanger posts 1164 interact with Supply channels 1168. The user then allows hanger posts 1164 to slide from first end 1170 to second end 1172 until base 1167 contacts second end 1172. To remove air supply unit 33 the user lifts unit 33 until each hanger posts 1164 slides from second end 1172 to first end 1170 allowing top 1165 to remove from channel 1168.

In alternative embodiments, bracket assembly 1150 could be placed on air supply 33 and an air supply bracket assembly 1152 could be placed on footboard 32. Additionally, channels 1168 could be cut into the back of air supply 33 eliminating the need of hanger body 1166.

Although the invention has been described in detail with reference to certain preferred embodiments, variations and modifications exist within the scope and spirit of the present invention.

What is claimed is:

1. A patient support comprising:
a frame;
a deck, coupled to the frame, to support a mattress;
an air supply; and
a footboard removably coupled to the frame, the footboard being formed from a single molding, the footboard including a body including a first side and a second side, a caregiver interface and an air supply retaining assembly, the air supply retaining assembly configured to removably couple the air supply to the footboard.

2. The patient support of claim 1, wherein the air supply is configured to provide air to the mattress.

3. The patient support of claim 1, wherein the air supply retaining assembly includes a footboard bracket assembly and an air supply bracket assembly.

4. The patient support of claim 3, wherein the air supply bracket assembly includes a pair of brackets.

5. The patient support of claim 4, wherein the footboard bracket assembly includes a bracket configured to receive the pair of brackets to couple the air supply to the footboard.

6. The patient support of claim 3, wherein the air supply bracket assembly includes body and a pair of posts.

7. The patient support of claim 6, wherein the footboard bracket assembly includes a bracket including a pair of channels configured to receive the pair of posts to couple the air supply to the footboard.

8. The patient support of claim 1, wherein the footboard further includes a pair footboard attachment members configured to couple to the frame.

9. The patient support of claim 8, wherein the frame includes a pair of footboard receivers, each of the pair of footboard receivers includes a receiver channel and a footboard receptacle.

10. The patient support of claim 9, wherein each of the footboard receptacles receives one of the pair of footboard attachment members.

11. The patient support of claim 10, wherein the receiver channels are configured to aid in placement of the footboard attachment members in the footboard receptacles.

12. The patient support of claim 1, wherein the footboard further includes a grip surface to aid in positive gripping of the footboard.

13. A patient support comprising:
a frame; and
a footboard removably coupled to the frame, the footboard including a body having a first side and a second side, the first side and the second side defining an interior, and a first conduit disposed within the interior, the first conduit defining a first channel adapted to receive a cable.

14. The patient support of claim 13, wherein the footboard further comprises a first receiver disposed adjacent the first conduit, the receiver adapted to receive a first electrical component.

15. The patient support of claim 14, wherein the footboard further comprises a second conduit disposed within the interior, the second conduit being spaced from the first conduit and defining a second channel adapted to receive a cable.

16. The patient support of claim 15, wherein the footboard further comprises a second receiver disposed adjacent the second conduit, the receiver adapted to receive a second electrical component.

17. The patient support of claim 16, wherein the first conduit and the second conduit comprise respectively a first tube and a second tube.

18. The patient support of claim 16, wherein the first electrical component comprises one of a first interface to control a bed scale and a second interface to control patient support functions.

19. The patient support of claim 18, wherein the second electrical component comprises the other of the one of the first interface and the second interface.

20. The patient support of claim 15, further comprising foam disposed within the interior, the foam adapted to provide strength to the footboard.
